(19) United States
(12) Patent Application Publication
(10) Pub. No.: US 2024/0365421 A1
(43) Pub. Date: Oct. 31, 2024

(54) 5G and Cloud Action Coordination for Continuous End-to-End Communication

(71) Applicant: Telefonaktiebolaget LM Ericsson (publ), Stockholm (SE)

(72) Inventors: János Harmatos, Budapest (HU); Balázs Varga, Budapest (HU); György Miklós, Pilisborosjenö (HU); János Farkas, Kecskemét (HU)

(21) Appl. No.: 18/687,977

(22) PCT Filed: Aug. 2, 2022
(86) PCT No.: PCT/IB2022/057166

§ 371 Date: Feb. 29, 2024

Related U.S. Application Data
(60) Provisional application No. 63/239,607, filed on Sep. 1, 2021.

(51) Int. Cl. H04W 76/25; H04L 41/06; H04W 76/15

(52) U.S. Cl. CPC H04W 76/25; H04L 41/06; H04W 76/15

(57) ABSTRACT

A method for coordinating application-related events in multiple network domains comprises, in a first network domain, receiving (710) a request, from a second network domain, to prevent events with respect to a first communications path in the first network domain, for a communications module. The method further comprises preventing or delaying (720) one or more actions in the first network domain that would interrupt connectivity in the first communication path, in response to the request.

### TECHNICAL FIELD

The present disclosure is generally related to communications and data networks and is more particularly related to techniques for ensuring continuity of application-related communications across multiple network domains.

### BACKGROUND

5G mobile technology is positioned to provide much wider range of services than the 3G/4G technologies. It is expected to enable a fully connected society, in which a rich set of use cases will be supported, from so-called Enhanced Mobile Broadband, through media distribution and Massive Machine Type Communication (M-MTC), to Mission Critical Services (Critical Machine Type Communication-C-MTC).

The C-MTC use case group covers a large set of applications, but most can be characterized by requirements for low latency and high reliability, as well as high availability. Although low latency is an important criterion in numerous use cases, high reliability is expected to be a basic requirement in much wider range of services. For example, low latency and high reliability are very important factors in Industry (Factory) Automation Use Cases (e.g., high speed motion control, robotized manufacturing, etc.), and several special subtasks of Smart Grid service. In these and in other use cases, guarantees on latency and reliability requirements together can provide the sufficient service quality.

High reliability is also important in some use cases where there are relaxed requirements on latency (e.g., where higher delay and/or higher jitter can be tolerated). Illustrative examples could be Intelligent Traffic Systems (ITS), remote controlling (with or without haptic feedback, Smart Grid, Mobile robot control, Drone Controlling, tele-surgery, etc. In these cases, extremely low latency is not a crucial factor, but high (and in some cases, extremely high) reliability of the connectivity between the application server and the C-MTC device is the most important requirement. To sum up, it can be said that reliability is a very important requirement in the case of use cases with low latency requirement, but reliability itself could be a critical characteristic of C-MTC services.

In most of the above-mentioned use cases, the controller application for a given application or service can be deployed in the cloud environment, i.e., in a server or servers outside the wireless network domain. Various advantages of the cloud system can be leveraged, such as dynamic and elastic resource handling, scalability, flexible application deployment management, robustness, etc. The cloud environment enables the deployment of multiple application instances by using different (infrastructure) resources (e.g., servers), so the level of service reliability could be increased. The cloud management system also provides life-cycle management of the multiple application instances belonging to a service deployment, such as application instance resource control (e.g., scaling), application replica management (e.g., re-deployment in a new place), handling the different types of failures in an automated way (e.g., self-healing).

The multiple application instances in the cloud can communicate with the terminal device(s) by leveraging the reliability approaches offered by the 5G system. One approach is to equip the terminal device with multiple UEs, i.e., with multiple transceivers and corresponding processing circuitry that together can independently communicate with the wireless network. This makes it possible to set up disjoint paths from these UEs, where the different UEs are, for example, handled by different gNBs and UPFs (PDU Session Anchors) in the network. This approach is illustrated in FIG. 1. As seen in the figure, a client device includes two UEs, UE1 and UE2, which establish connections to separate base stations, gNB1 and gNB2. These separate base stations may in turn be connected to separate Access and Mobility Management Functions (AMFs), shown in the figure as AMF1 and AMF2, and separate user plane functions (UPFs), illustrated as UPF1 and UPF2. User-plane sessions are handled by session management functions (SMFs), SMF1 and SMF2, corresponding to the distinct PDU sessions established with the application or service in the data network (DN).

Another alternative is to use the Dual Connectivity feature as standardized by the 3rd-Generation Partnership Project for 4G and 5G networks, which allows a single UE that is suitably equipped with two transceivers to have user plane connectivity with two gNBs. In this case, the UE may establish two PDU sessions, such that the core network (CN) selects separate UPF entities, with the CN also requesting the radio-access network (RAN) to establish dual connectivity and to handle the first PDU session via the Master gNB (MgNB) and handle the second PDU session via the Secondary gNB (SgNB). The details of the above-mentioned reliability approaches provided by the 5G network are discussed in 3GPP TS 23.501. This approach is illustrated in FIG. 2.

### SUMMARY

In the wireless network domain, e.g., in a wireless communications network implemented according to standards developed by 3GPP, techniques such as the use of redundant UEs and/or dual connectivity may be used to provide a client with redundant communications paths through the wireless network, such that the wireless communications provided to the client are highly reliable. Additional techniques may be used to ensure that interruptions in these redundant communications paths do not occur at the same time.

To ensure high reliability in the end-to-end communications between a client application and an application or service provided to the client from a server or servers in the cloud domain, the redundant communications paths through the wireless network may be matched to redundant communications paths and application/service instances in the cloud domain. However, interruptions in those communication paths or in the availability of an application instance or service instance in the cloud domain might also occur. If one of these interruptions occurs in a cloud domain communication path or an application instance at the same time as an interruption occurs in the corresponding communication path in the wireless network domain, the client application may not receive the quality of service it requires, with respect to connection reliability and/or communications latencies.

Various embodiments of the techniques and systems described below address these problems. In some of these embodiments, an event coordination function is defined for managing the coordination of the action performed in the 5G (wireless network) and the cloud domains. By using an exposure Application Programming Interface (API) for the event coordination function, authorized cloud management entities can send lock requests to inform the event coordination function about needed or planned actions in the cloud domain. This ensures that the events in the 5G and the cloud domain can be harmonized, and that avoidance of communication outages can be guaranteed in end-to-end scope. The API may also enable authorized cloud management entities to check the status of UEs belonging to a certain terminal device, to assist the scheduling of related actions in the cloud domain.

An example method for coordinating application-related events in multiple network domains, according to some of the embodiments described herein, comprises, in a first network domain, receiving a request, from a second network domain, to prevent events with respect to a first communications path in the first network domain, for a communications module. This example method further comprises, in response to the request, preventing or delaying one or more actions in the first network domain that would interrupt connectivity in the first communication path.

Another example method for coordinating application-related events in multiple network domains in a system comprising at least a first network domain and second network domain, comprises, in the second network domain, determining that a temporary lock on actions regarding a first communication path in the first network domain is needed, to prevent service discontinuity for an application in the second network domain serving a communications module connected to the application through the first network domain. This example method further comprises sending a request, to the first network domain, to prevent events with respect to the first communications path in the first network domain, for the communications module.

Apparatuses and systems corresponding to the methods summarized above are described in detail below.

The techniques and systems summarized above, as further described below, may be used to facilitate the maintenance of uninterrupted communication for a terminal device where multiple application instances are deployed in a cloud environment and wireless-network-based reliability options are applied for connecting the application instances with the device over a 5G network. Other advantages will be apparent upon reading the following description and viewing the accompanying figures.

### BRIEF DESCRIPTION OF THE FIGURES

FIG. 1 illustrates a conventional reliability approach in which a terminal device is equipped with multiple physical UEs.

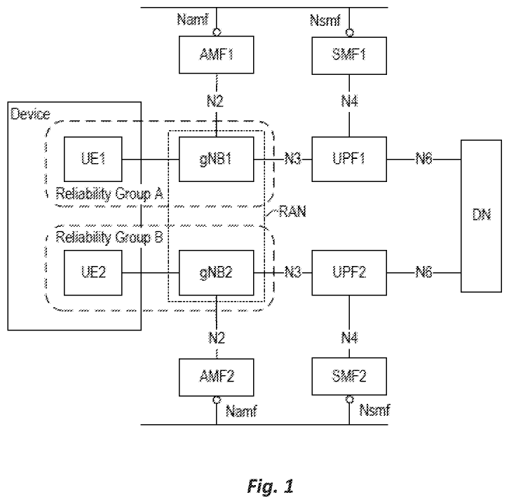

FIG. 2 illustrates another conventional reliability approach based on the dual connectivity (DC) feature of 5G or 4G/LTE networks.

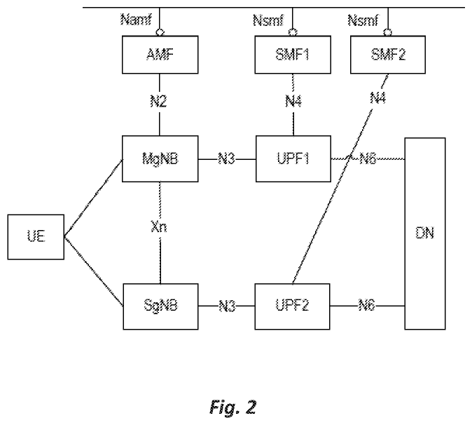

FIG. 3 illustrates the end-to-end (E2E) effect of parallel, uncoordinated events in the 3GPP wireless network domain and the cloud domain.

FIG. 4 shows an example of a system for providing for coordination of actions in 5G and cloud domains.

FIG. 5 illustrates an example of a lock request handling process.

FIG. 6 shows an example of a process for handling concurrent lock requests.

FIG. 7 is a process flow diagram illustrating an example method according to some embodiments.

FIG. 8 is a process flow diagram illustrating another example method according to some embodiments.

FIG. 9 illustrates an example communications system, according to some embodiments.

FIG. 10 illustrates an example coordination node, according to some embodiments.

### DETAILED DESCRIPTION

Below, the description of various techniques and systems may refer to the “3GPP domain” or “5G network domain,” both of which may be understood as examples of a wireless network domain, where the term “wireless network domain” may be understood as encompassing a radio access network and a core network, to the extent the wireless network has an identifiable core network. It should be understood that techniques or concepts described with respect to the 3GPP domain or 5G network domain are applicable more broadly to other wireless network domains, and particularly with wireless network domains that support redundant wireless communication links to a client application, e.g., through the use of multiple-UEs, dual connectivity, and the like.

The 3GPP domain, or, more generally, the wireless network domain, interfaces with the cloud domain, e.g., via the 5G user plane function (UPF), where the term “cloud domain” may be understood to refer to a data network or collection of data networks connected to one another, e.g., the internet, in which an application or service to may be provided to a client in a wireless terminal operating in the wireless network domain, by one or several application instances or service instances executing on one or several servers in the cloud domain.

In the case of redundant paths in the 5G network domain, it has been identified that mobility and PDU Session Anchor (PSA) relocation events require special attention. It may happen that UEs embedded in the same terminal device perform handover at the same time (or at overlapping times). This leads to an interruption in the communication, since neither of the UEs in the device can communicate with, for example, the corresponding application instances in the cloud. Similar problem arises if PSA relocation occurs. In both cases, the length of the communication disruption can cause significant impact on a service performance (e.g., safety stop of a manufacturing robot).

To address these problems, a handover coordination framework as well as a coordinated PSA change solution are described in International Patent Application Publication WO/2019/011434 A1 and International Patent Application Publication WO/2021/079171 A1, respectively, of which the entire contents of each are incorporated herein by reference. One approach described in the former uses a central event coordination functionality, which enables the 3GPP entities that handle the UEs belonging to the same terminal device to synchronize their actions. Practically, if a device is equipped by UE_1 and UE_2 and a handover is performed for UE_1, then the corresponding Access and Mobility Management Function (AMF) that handles UE_1 applies a handover “lock” in a coordination database. During this locking period, no other actions are allowed to be executed for the other UE belonging to the same device. This guarantees that no communication outage will happen. Another approach uses direct coordination between the entities that handle the UEs belonging to the same device. In this case, gNB_1, which handles UE_1, and gNB_2, which handles UE_2, can signal to each other directly, to coordinate the handover timing. These approaches could also be applied for PSA change.

The solutions described above ensure that communication outage can be avoided in the 5G network domain. However, when considering an end-to-end approach, the cloud domain should also be considered. In the cloud domain, any of several different events, that impact an application instance (e.g., cloud management actions, failures) may occur. For example, application relocation is performed due to various failure scenarios in the platform or infrastructure level, where these failure scenarios might involve a failure in the execution environment, a VM failure, a Pod failure in Kubernetes, or a physical server failure. The cloud management system can also perform deployment changes due to resource optimization. In all the above cases, communication outage occurs regarding the impacted application instance.

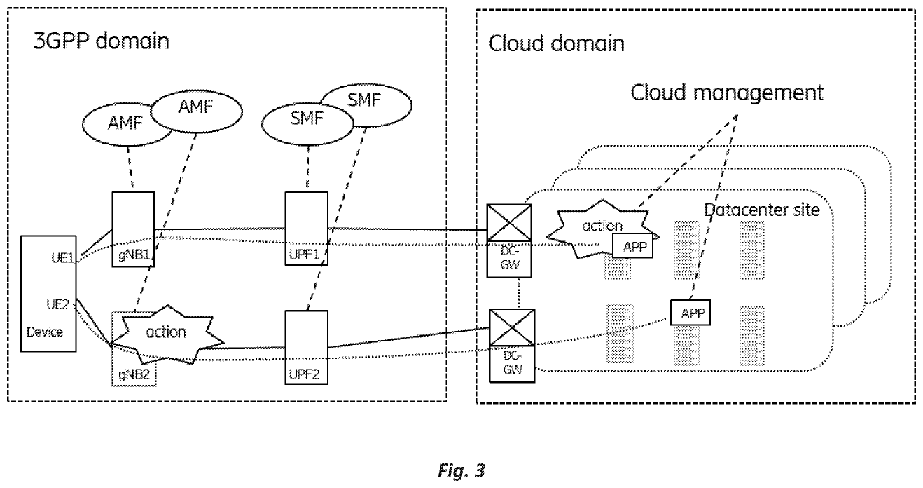

In normal operation of applications where redundancy is employed to improve reliability, communication interruption involving a single application instance is not a problem, since multiple application instances are running in the cloud, so there will be always at least one that can handle the communication with the device. However, it may happen that while one application instance is impacted and cannot communicate, due to some reason in the cloud domain, a 5G network action (e.g., handover or PSA changes) might be executed on the communication path that connects the working application instance and the device. In this case, as illustrated in FIG. 3, even if there are two independent paths in the mobile network domain, and there is a coordination of events in the mobile network domain as well as multiple application instances in the cloud domain, there will be a communication outage, which can impact the service performance. Thus, end-to-end uninterrupted communication is not guaranteed by previously disclosed techniques, even if redundant paths are established between the application and the terminal device.

According to several embodiments of the techniques described herein, an event coordination function is deployed in the 3GPP domain. In these embodiments, the event coordination function is responsible for managing the timing of the events performed (or planned to be performed) in the 3GPP domain as well as in the cloud domain (outside the 3GPP domain in general) in an integrated way. It provides that the actions/events in the 3GPP network and in the cloud domain are coordinated, such that there will be at least one path between the terminal device and an application instance in the cloud where uninterrupted communication is guaranteed.

When a service instance is deployed in the cloud domain, the cloud management function controlling the service instance can authenticate itself and obtain information about the UEs served by the application instances (belonging to the service) through 3GPP-provided service application programming interfaces (APIs).

If an action is planned or needed to be executed by the cloud management, the cloud management sends a Lock request message to the event coordination function, with the lock request message specifying the details of the action (e.g., the type of action, the action's priority, expected duration of the action, etc.).

The event coordination function may investigate or evaluate whether the lock is acceptable, according to the current situation in the 3GPP domain. Potential conflicts may exist, for example, when there is already a lock for the corresponding UE(s) in the 3GPP domain, or an expected action is coming soon in the 3GPP domain. To assist in this evaluation, different services provided by the analytics functions in the 3GPP domain (e.g., the Network Data Analytics Function) could be invoked.

When the lock request by the cloud management is accepted and the lock is applied, the event coordination function is responsible, in some embodiments, to handle the situation when another action should be performed in the 3GPP domain, when an action conflict occurs. In this scenario, the event coordination function may analyze the concurrent actions and decide to reject the 3GPP-initiated action (e.g., handover will be delayed), or decide to suspend the active lock initiated by the cloud domain. In the latter case, the cloud domain may be informed about the decision-optionally a delayed lock suspension could be applied by the event coordination function, so the cloud management can react/adapt to the situation. If the action in the 3GPP domain is completed, then the lock initiated by the cloud management may be restored and the cloud domain informed.

These and the related solutions described herein enable the authorized cloud management entity to obtain status information about the 3GPP domain, to optimize the time of the scheduled actions in the cloud domain. Various embodiments of the techniques and systems described herein address these problems.

In some of these embodiments, an event coordination function is defined for managing the coordination of the action performed in the 5G (wireless network) and the cloud domains. By using an exposure Application Programming Interface (API) for the event coordination function, authorized cloud management entities can send lock requests to inform the event coordination function about needed or planned actions in the cloud domain. This ensures that the events in the 5G and the cloud domain can be harmonized, and that avoidance of communication outages can be guaranteed in end-to-end scope. The API may also enable authorized cloud management entities to check the status of UEs belonging to a certain terminal device, to assist the scheduling of related actions in the cloud domain.

Also discussed below are details of how the lock requests that come from the cloud management are handled by the event coordination function, as well as how such cases are managed when concurrent actions would be needed in the 5G and the cloud domain at the same time.

Advantages of various embodiments of the techniques and systems described herein include that they may be used to facilitate the maintenance of uninterrupted communication for a terminal device if multiple application instances are deployed in a cloud environment and the 3GPP enabled reliability options are applied for connecting the application instances with the device over a 5G network. Required actions in the wireless network domain (e.g., handover, anchor change) and in the cloud domain (e.g., application re-deployment) can be executed in a coordinated way, to avoid any communication outage. For example, if an action is planned in one domain (no immediate execution is necessary), then the execution can be scheduled by considering the status of the other domain. In various embodiments, both the wireless network and cloud domains can consider any extraordinary situation that occurred in the other domain. Handling of simultaneous actions in the wireless network domain and the cloud domain may also be provided by using conflict resolution.

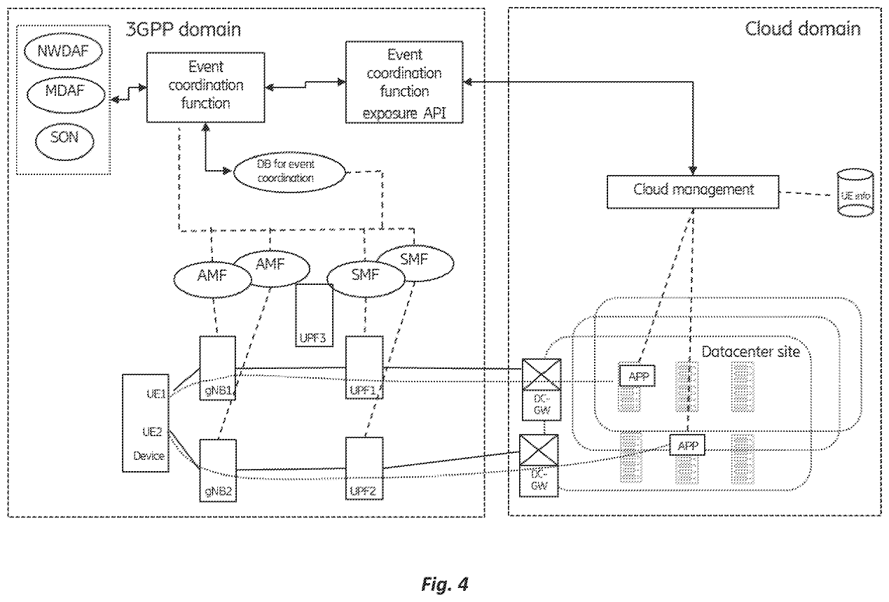

A functional view of the proposed solution can be seen in FIG. 4.Error! Reference source not found. In this figure, the event coordination function and the event coordination function exposure API, as pictured in the 3GPP domain, are new, compared to previously existing specifications for 3GPP networks. Several functions described in the previous patent applications mentioned above, such as the database for event storing event coordination information in the 3GPP domain and the cloud management capability in the cloud domain, are extended with new functionality, to consume the services of the new event coordination function).

On the left-hand side, a simplified view of the 3GPP User Plane (UP) and Control Plane (CP) network architecture can be seen, according to 3GPP TS 23.501, as well as the event coordination function, which is responsible for the coordination of the actions/events initiated in the 3GPP or in the cloud domain. A database is also maintained, to store all the lock request related information. If a central event coordination approach is used in the 3GPP domain to coordinate handovers and anchor changes, then a common database could be used to store lock requests coming from the cloud and the 3GPP domains in a single place. If a direct coordination approach is used instead, i.e., where base stations directly coordinate their activities with one another, then the database may store only the cloud (or external) domain related lock information.

The client device that is controlled by the application instances/replicas deployed in the cloud domain can be equipped with a single UE or multiple UEs. In either case, this device can be referred to as a communications module. In the single-UE case, reliability in the 3GPP network domain may be provided by using dual connectivity, while in the duplicated (or multiple)-UE case, different PDU Sessions are established, using different user plane (UP) and control plane (CP) network entities, such as gNBs, UPFs, AMFs, and SMFs. In both cases, the communications module able to communicate with multiple application instances at the same time.

FIG. 4 shows a case where duplicated paths are established between a certain device and the serving application instances, with a 1:1 mapping between a UE and an application instance. However, using IEEE 802.1CB Frame Replication and Elimination for Reliability (FRER) the robustness of the communication system could be increased, such that a 1:1 mapping can be generalized to N:M mapping. This means that much less strict lock statements may be used, such as a requirement that 2 of 4 paths should remain operational. This in turn may result in fewer event lock conflicts. However, event/action coordination is still needed in this generalized case, to ensure continuous availability.

Since the event coordination function is responsible for managing lock requests coming from the cloud domain, an exposure API is provided for accessing its services from outside the 3GPP domain. The exposure API can be deployed according to the 3GPP CAPIF framework, for example, as specified in 3GPP TS 23.222. The service provided by the API could be a potential extension of the SEAL services, as specified in 3GPP TS 23.434.

In the cloud domain, for increased reliability, multiple application instances may be deployed in different sites, servers, VMs, and/or containers, depending on the cloud platform and execution environment as well as the target reliability level. More isolated application deployment guarantees higher redundancy. The cloud management is responsible, among other things, for handling user request for application deployment, provisioning and orchestration (application workload placement, resource assignment), monitoring of the deployed application instances, application life-cycle management (resource scale-in/out, automated application replica management, etc.) and service assurance (e.g., automated failure handling).

In response to a service request coming from an enterprise user, the cloud management system performs an application deployment (workload placement, resource assignment, etc.) that fulfills the service reliability requirements. Then, the communication is established with the terminal device via multiple, independent paths over the 3GPP network domain.

Depending on the type of the service, one application instance can serve a single device or multiple terminal devices. In both cases, the cloud management maintains the association between a certain application instance and the served UE(s).

### Handling of Lock Request Initiated by the Cloud Management

According to some embodiments, if any action that impacts the operation of a certain application instance is required to be executed in the cloud domain, the event coordination function exposure API is invoked. Different type of actions/events may be considered. On one hand, the action can be a planned action, for example: a re-deployment of an application instance is required due to performance reasons, an application image update is initiated by the user, etc. In some of these cases, immediate execution is not critical, and the cloud management can then take the current status of the 3GPP domain into account when planning when or how to perform the cloud domain action. On the other hand, however, some actions may be required to handle an extraordinary event, such as a failure in the infrastructure/virtualization layer that impacts at least one application instances. In this case, the cloud management can inform the 3GPP domain about the failure situation/handling and the current outage of application instances, which impacts communication path(s) towards certain terminal device(s).

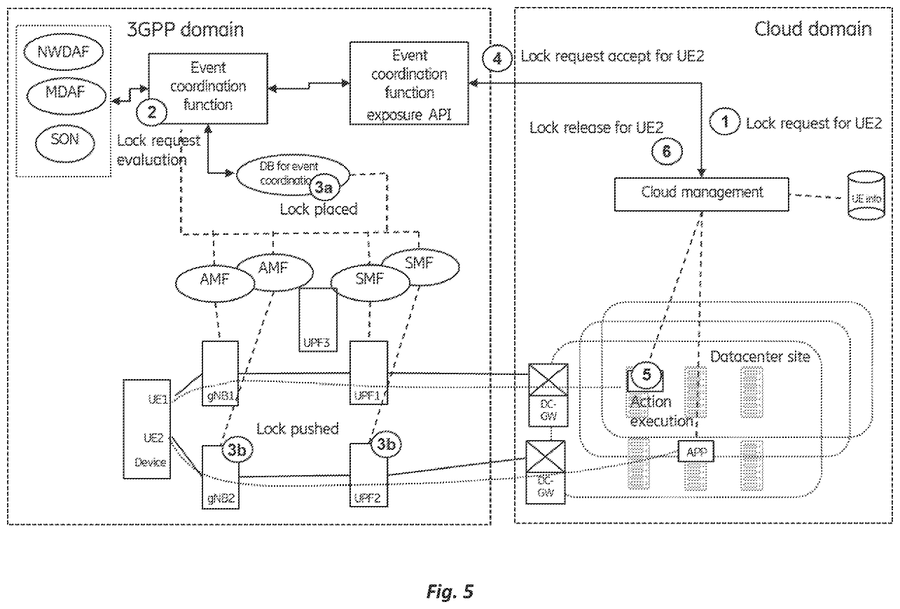

FIG. 5 illustrates an example of the lock request handling process.

According to step 1 on FIG. 5, the cloud management generates a lock request message for the impacted streams, to inform the 3GPP domain and secure that there will no change allowed regarding the PDU Session(s) that serve these UEs belonging to the streams. The mapping between the streams and the PDU Session(s), as well as the identification of the impacted UEs for which the locking mechanism should be applied can be performed by the event coordination function.

The message may contain some or all of the following parameters (depending on the capabilities of the cloud management as well as the action):
Lock_id: identifies the request on both the 3GPP and the cloud domain side.
Stream-ID: some form of an ID makes clear for the Event coordination function what PDU-session(s)/UE(s) are affected. It can be possible to derive the ID e.g., from the unicast or multicast MAC or IP addresses used by the streams, or from an application-level identifier.
Type of the action: e.g., planned (and not critical to start right now), immediate execution preferred, execution is on-going (failure handling).
A priority value: used for specifying the importance of the action. The priority can depend on the type of the action (e.g., failure handling has high priority), as well as the service characteristics (such as tolerance to communication outage). The priority parameter can be considered if parallel actions should be executed in the 3GPP and in the cloud domains.
The expected duration of the action: informs the 3GPP domain about the (expected) completion time of the action.
Postpone option/time: If the action executed could be executed/scheduled later, then it can be specified how much time it can be postponed.
Timeout. In this field the cloud management can propose a time period during which the lock should be applied; if the period passed, the lock is released anyway. This helps to handle any failure case in the cloud management plane that may cause that the lock could not be released by the cloud management.
Lock-level: How many of the affected PDU Sessions must remain operational. (For example: there are 3 independent communication paths are established using 3 PDU Sessions between the device and the application instances and at least one path should remain operational in any case. If one PDU Session is impacted by an action executed in the cloud domain, then an action that impact only one of the remaining 2 PDU Sessions can be performed in the 3GPP domain simultaneously).

Once the Lock request message is assembled, it is sent to the event coordination function, which checks whether the request is applicable depending on the specified parameters of the request and the current status in the 3GPP domain (step 2):
It may happen that currently a lock—initiated by a 3GPP control plane entity (AMF/SMF)—exists for the given UE(s), due to an on-going handover or anchor change. In this case, the lock requested by the cloud domain may be accepted only if the ongoing action is completed and the current lock is released by the corresponding 3GPP entity, unless the priority of the lock from the cloud domain has a higher priority than the current lock.
Optionally, the Event coordination function can invoke 3GPP radio, core network entities/functions and/or analytics services (e.g., NWDAF services) to check whether any action is expected in the 5G network while the lock should be kept up. For example: if a handover is expected soon for a certain UE, then it is performed first and then the lock request coming from the cloud management can be applied. In this case, the above mentioned postpone and priority parameters in the Lock request message can be considered.
If the lock request is accepted but urgent action is needed in the 3GPP domain (e.g., performing a handover that may cause some communication outage, but it has significant less negative effect on the service performance than radio signal quality degradation due to the delayed handover) then the active lock can be suspended and the action in the 3GPP network can be executed. The cloud domain can be informed in this case. Details of this option will be further discussed below.
If other domain(s) (e.g., a TSN transport domain that interconnects the 5G and the Cloud domains) is involved in the communication and if the responsible domain management can inform the Event coordination function (via the Exposure API) about the domain capabilities, then this information can also be considered in the decision.
Such other domains may also request a lock if coordination is needed due to an action, similarly as the cloud domain.

If the Lock request can be accepted, then the event coordination function notes that the applied lock is initiated by the cloud management system (outside of the 3GPP system) and stores the parameters specified in the Lock request message (priority, expected duration of the lock, timeout, etc.). This information can be considered if any lock/action request for the same UE(s) is coming from any 3GPP control plane entities (example details will be discussed below).

If the central event coordination approach for wireless domain actions/events is applied in the 3GPP domain, then the cloud-domain-initiated lock for handover and anchor change may be placed for the involved UE(s) in the same coordination database (step 3a). If the direct coordination approach is applied, then the event coordination entity pushes a lock message towards the 3GPP CP and UP entities that handle the involved UE(s) (Step 3b). The lock message contains information indicating that it was initiated by a (management) entity outside of the 3GPP domain. This enables operation such that if an action (e.g., a handover) should be performed in the 3GPP domain while there is an active lock, then the responsible gNB can invoke the event coordination function for resolving the case (see below for handling of concurrent actions).

Furthermore, a lock request accept message may be sent back to the cloud management system (step 4). The message may contain a timeout field, where the event coordination function indicates the maximum time while the lock will be maintained.

Then, the required action(s) regarding the application deployment can be performed in the cloud domain (step 5).

When each required action is completed in the cloud domain, the cloud management may send a lock release message to the event coordination function (step 6) and release the lock in the database or inform the involved 3GPP entities on this. If the action execution in the cloud domain is not completed within a time period specified in the Timeout parameter, then the cloud management may send a lock extension message to the 3GPP domain, to ask the event coordination function to keep the lock. The event coordination function can then make the above-described evaluation to decide whether the extension of the lock is applicable on the 3GPP domain side.

If the lock request cannot be applied due to any reason in the 3GPP domain, a lock request reject message may be sent back to cloud management. The event coordination function can specify the duration during which the lock request from the cloud domain will not be accepted.

Even in this case, the lock request is noted by the Event coordination function and based on the Lock_id, a lock request notification message can be sent to the corresponding cloud management entity if the lock can immediately be applied, if needed.

### Handling of Concurrent Lock Requests

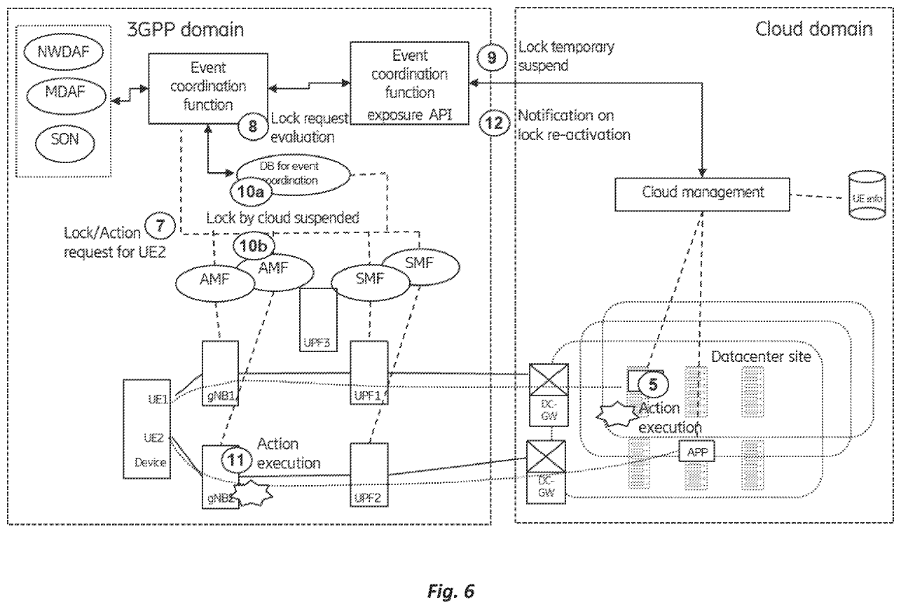

FIG. 6 illustrates an example of a process for handling concurrent lock requests. In the present context, the term “concurrent lock request” refers to the situation where an action is to be executed in the 3GPP domain (step 7 on FIG. 6—e.g., HO event for UE2) while there exists an active lock for this UE, due to an on-going or the scheduled action in the cloud domain, such that the parallel actions may cause a communication outage at the same time on each path towards a terminal device.

In the case of central event coordination within the wireless network domain for wireless domain events, when a lock request for a certain UE arrives from a 3GPP CP entity, the event coordination function may recognize that an active lock already exists for the given UE, i.e., recognize that there is a concurrent lock request situation. In the case of direct coordination of wireless network domain-related actions, if the action execution in the 3GPP domain seems to be important/critical (for this, a priority value can be used when applicable), then the responsible 3GPP entity (e.g., AMF) may invoke the event coordination function so that it can check for a concurrent lock request situation and, if one exists, to resolve the conflict of the events. Then the required action in the 3GPP domain will be evaluated (step 8), based on its importance as well as the impact of ignoring the active lock. The evaluation could be based on fine-grained rules or priority values that can be continuously tuned based on the evaluation of previous decisions. Additionally, analytics services, which may be artificial-intelligence-based, can be invoked to evaluate each decision case.

If the outcome of the decision is to reject the 3GPP entity-initiated request, then the request can be noted by the event coordination function and, when the cloud management system releases the lock, the event coordination function can send an immediate trigger to the corresponding 3GPP entity, and the action is executed. Note that a rejection could be applied if the delay of the required action in the 3GPP domain is not critical and/or the communication performance is not impacted due to the delay (e.g., delay of an anchor change could be tolerated by the service, or handover could also be delayed for a certain time without serious communication performance degradation). It should be noted that the event coordination function can decide at any time that the active lock request (initiated by cloud management) should be suspended (for example, if the expected duration of the action(s) in the cloud domain is significantly longer than it was specified in the Lock request message).

The acceptance of the lock initiation coming from a 3GPP CP entity may occur in (but is not limited to) the following cases:
the effect of the communication interrupt due to the simultaneous outages along the multiple paths is less critical than the effect of the delayed action in the 3GPP domain. An illustrative example could be a handover, which can be performed in relative short time and where the service could tolerate such a communication outage, otherwise radio signal loss may occur.
The priority of the lock request coming from the cloud management was low, so (temporary) ignoring of the lock request is acceptable.

In this case the active lock initiated by the cloud management will be suspended, and the event coordination function determines whether an immediate suspension is needed or whether the lock will be suspended just after a certain time. In both cases, the event coordination function sends a lock temporary suspend message (step 9) to notify the cloud management that the locking is/will be (temporarily) ignored:
If the locking is not suspended immediately then the message may contain the time when the Event coordination function will suspend the active lock. Then, the cloud management could consider that the lock will be released within a certain time and may adapt the on-going actions in the cloud domain accordingly.
The message optionally could contain the expected period of the temporary lock suspend.

In the case that central event coordination is used, the lock request initiated by a 3GPP entity is placed in the coordination database (step 10a). In the case of direct coordination, the event coordination entity pushes a lock suspend message to the corresponding 3GPP entity (step 10b), which can start the direct coordination procedure.

Then, execution of the required action in the 3GPP domain is started (step 11). In the case of central event coordination approach, when the action is completed, the corresponding 3GPP entity releases the lock in the event coordination database. Then, the event coordination function recognizes it and restores the lock initiated by the cloud management. In the case of direct coordination approach, when the action is completed, the corresponding 3GPP entity informs the event coordination function about it.

Then, the suspended lock is restored (lock is placed in the database or pushed to the corresponding 3GPP entities as described above) by the event coordination function and at the same time a lock notification message is sent (step 12) by informing the cloud management that the locking is active again.

### Status Report Request

In some embodiments, where enabled by the Event coordination function API, the cloud management system can send a status report request message to get information about whether there is any expected action/event in the 3GPP domain. The event coordination function can get this information by invoking 3GPP radio, core network entities/functions and/or analytics services (e.g., NWDAF, MDAF, SON). A status report response generated by the event coordination function may contain the summary of the above information. It can be used by the cloud management to schedule planned actions in the cloud domain, to minimize the probability of locking conflicts with events/actions in the wireless network domain.

### Generalizations

Although details of action/event coordination between the cloud and 3GPP domains are described above, the described techniques can work for other domains as well, such as a transport domain that interconnects the 5G and the Cloud domains. In a similar way as described above, if there is any type of event occurs in a certain domain, the responsible domain manager in one domain can send a lock request message to an event coordination function in another domain, e.g., in the 3GPP domain, with the described lock handling and conflict resolution methods then being applied.

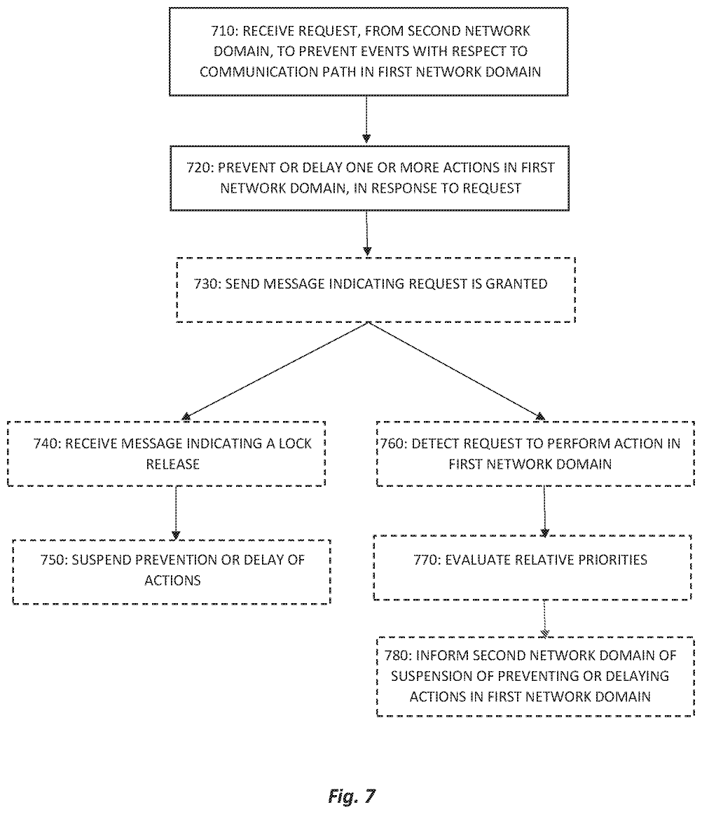

FIG. 7 is a process flow diagram illustrating an example method for coordinating application-related events in multiple network domains. This example method may be understood as a generalization of various embodiments or instances of the techniques described above, from the perspective of a coordination function in a first network domain, such as a 3GPP wireless network domain. Accordingly, when terminology that differs from that used above is used, but with respect to concepts or steps already described herein, the terminology used in the following description is meant to encompass the things already described. Further, variations of the techniques described above may be applied to the illustrated method.

The steps shown in FIG. 7 may be performed in an event coordination function, which may be implemented in one or several physical nodes in the or associated with the first network domain. These steps include, as shown at block 710, the step of receiving a request in the first network domain, from a second network domain, to prevent events with respect to a first communications path in the first network domain, for a communications module. This message might be referred to as a “lock request,” for example, and acts as a request to prevent network actions or events that will cause or have the potential to cause interruptions in the first communication path. As discussed above, the communications module here may comprise one or more instances of a UE, in various embodiments or instances.

The illustrated method further includes, as shown at block 720, the step of preventing or delaying one or more actions in the first network domain that would interrupt connectivity in the first communication path, in response to the request.

The first communications path may be one of multiple communications paths in the first network domain associated with the communications module, for example.

In some embodiments, the first network domain is a wireless communications network and the second network domain is a cloud network domain. In some of these embodiments, the first communications path includes a wireless connection between a first instance of a user equipment in the communications module and a first access point in the wireless communications network. This communication path might include one link in a dual-connectivity scenario, for example, or one of multiple wireless links established by multiple UEs in the communications network, in various embodiments or instances. In some embodiments, preventing or delaying one or more actions in the first network domain (as shown in block 720) may comprise preventing or delaying a handover of the wireless connection. In some of these and/or in some other embodiments, preventing or delaying one or more actions in the first network domain may comprise preventing or delaying a PDU Session Anchor (PSA) relocation event corresponding to the first communications path for the communications module.

In some embodiments or instances, the request may comprise one or more of any of the following parameters: an identifier for identifying the request in the first and second network domains; a stream or session identifier indicating which of one or more PDU sessions are affected by the request; a type of action planned by the second network domain, with respect to a communications path associated with the communications module in the second network domain; a parameter indicating an importance of an action planned by the second network domain, with respect to a communications path associated with the communications module in the second network domain; a parameter indicating a duration of an action planned by the second network domain, with respect to a communications path associated with the communications module in the second network domain; a parameter indicating a proposed duration for locking out events with respect to the first communications path in the first network domain; and a parameter indicating how many of multiple PDU sessions associated with the communications module should remain operational.

In some embodiments or instances, the illustrated method may further comprise sending, to the second network domain, a message indicating that the request is granted. This is shown at block 730. This message may indicate, for example, a time period during which the one or more actions will be prevented.

In some embodiments or instances, the method may further comprise receiving, from the second network domain, a message indicating a lock release and, in response to receiving the message indicating the lock release, suspending any prevention or delay of one or more actions in the first network domain that would interrupt connectivity in the first communication path. These steps are shown at blocks 740 and 750.

In some embodiments or instances, the method may further comprise detecting, while preventing or delaying one or more actions in the first network domain that would interrupt connectivity in the first communication path in response to the request, a request to perform an action in the first network domain that would interrupt connectivity in the first communication path. This is shown at block 760. In these embodiments or instances, the method may further comprise evaluating relative priorities of the requested action in the first network domain and an event in the second network domain associated with the request, as shown at block 770, and, based on this evaluation, selectively informing the second network domain of whether the preventing or delaying one or more actions in the first network domain that would interrupt connectivity in the first communication path is to be suspended, in favor of the requested action in the first network domain, as shown at block 780.

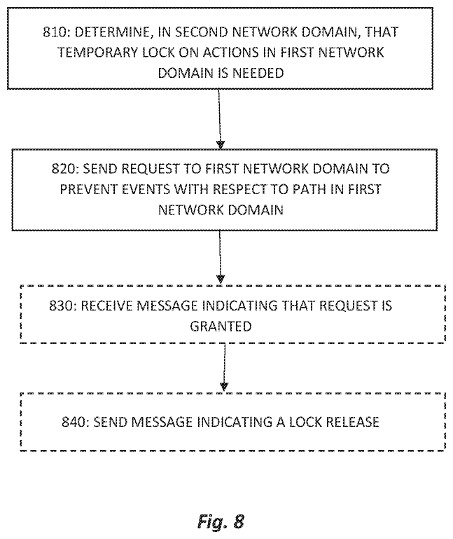

FIG. 8 illustrates another example method for coordinating application-related events in multiple network domains in a system comprising at least a first network domain and second network domain, in this case from the perspective of a management function in the second network domain, such as a cloud domain. Again, this example method may be understood as a generalization of various embodiments or instances of the techniques described above, and where terminology that differs from that used above is used, but with respect to concepts or steps already described herein, the terminology used in the following description is meant to encompass the things already described. Further, variations described above are applicable to the method shown in FIG. 8, even if not expressly mentioned below. The method may be implemented in one or several physical nodes, in various embodiments.

The method shown in FIG. 8 includes, as shown at block 810, the step of determining, in the second network domain, that a temporary lock on actions regarding a first communication path in the first network domain is needed, to prevent service discontinuity for an application in the second network domain serving a communications module connected to the application through the first network domain. The method further comprises, as shown at block 820, sending a request, to the first network domain, to prevent events with respect to the first communications path in the first network domain, for the communications module.

As was the case with the method shown in FIG. 7, the first communications path may be one of multiple communications paths in the first network domain associated with the communications module. Likewise, the first network domain may be a wireless communications network and the second network domain a cloud network domain, in some embodiments. In these embodiments, the first communications path may include a wireless connection between a first instance of a user equipment in the communications module and a first access point in the wireless communications network.

In some embodiments or instances, determining that the temporary lock is needed may comprise detecting, in the second network domain, any one or more of: an execution environment failure relating to the application; a virtual machine failure relating to the application; a server failure relating to the application; and a relocation of an application execution environment for the application. These are, of course, examples. Any type of operation or action that impacts or potentially impacts a communications path in the cloud or an application or service instance in the cloud may be considered.

In some embodiments or instances, the request may comprise one or more of any of the following parameters: an identifier for identifying the request in the first and second network domains; a stream or session identifier indicating which of one or more PDU sessions are affected by the request; a type of action planned by the second network domain, with respect to a communications path associated with the communications module in the second network domain; a parameter indicating an importance of an action planned by the second network domain, with respect to a communications path associated with the communications module in the second network domain; a parameter indicating a duration of an action planned by the second network domain, with respect to a communications path associated with the communications module in the second network domain; a parameter indicating a proposed duration for locking out events with respect to the first communications path in the first network domain; and a parameter indicating how many of multiple PDU sessions associated with the communications module should remain operational.

In some embodiments or instances, the method may further comprise receiving, from the second network domain, a message indicating that the request is granted. This is shown at block 830. In some of these embodiments or instances, the message indicating that the request is granted may indicate a time period during which the one or more actions will be prevented.

In some embodiments or instances, the method may further comprise sending, to the first network domain, a message indicating a lock release. This is shown at block 840, and, in some embodiments or instances, may be in response to determining that an action or event that triggered the lock request has been completed or is no longer occurring or anticipated.

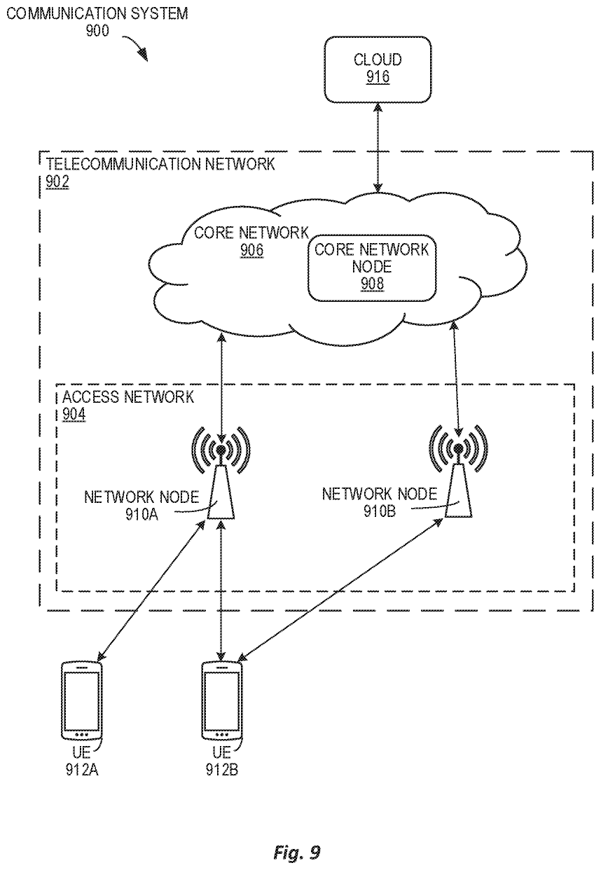

FIG. 9 shows an example of a communication system 900 in accordance with some embodiments. This figure provides an example context for implementation of the techniques described herein.

In the example, the communication system 900 includes a telecommunication network 902 that includes an access network 904, such as a radio access network (RAN), and a core network 906, which includes one or more core network nodes 908. The access network 904 includes one or more access network nodes, such as network nodes 910a and 910b (one or more of which may be generally referred to as network nodes 910), or any other similar 3rd Generation Partnership Project (3GPP) access node or non-3GPP access point. The network nodes 910 facilitate direct or indirect connection of user equipment (UE), such as by connecting UEs 912a and 912 (one or more of which may be generally referred to as UEs 912) to the core network 906 over one or more wireless connections. These wireless connections may include redundant wireless connections for one or more terminal devices, e.g., using dual-connectivity or dual-UEs, as was discussed above.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 900 may include any number of wired or wireless networks, network nodes, UEs, and/or any other components or systems that may facilitate or participate in the communication of data and/or signals whether via wired or wireless connections. The communication system 900 may include and/or interface with any type of communication, telecommunication, data, cellular, radio network, and/or other similar type of system.

The UEs 912 may be any of a wide variety of communication devices, including wireless devices arranged, configured, and/or operable to communicate wirelessly with the network nodes 910. Similarly, the network nodes 910 are arranged, capable, configured, and/or operable to communicate directly or indirectly with the UEs 912 and/or with other network nodes or equipment in the telecommunication network 902 to enable and/or provide network access, such as wireless network access, and/or to perform other functions, such as administration in the telecommunication network 902.

In the depicted example, the core network 906 connects the network nodes 910 to one or more hosts, such as hosts in cloud 916, which may comprise one or several interconnected data networks. These connections may be direct or indirect via one or more intermediary networks or devices. In other examples, network nodes may be directly coupled to hosts. The core network 906 includes one more core network nodes (e.g., core network node 908) that are structured with hardware and software components. Features of these components may be substantially similar to those described with respect to the UEs, network nodes, and/or hosts, such that the descriptions thereof are generally applicable to the corresponding components of the core network node 908. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF). One or more core network nodes 908 may correspond to the event coordination function described above.

Hosts in cloud 916 may be under the ownership or control of a service provider other than an operator or provider of the access network 904 and/or the telecommunication network 902 and may be operated by the service provider or on behalf of the service provider. The host 916 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 900 of FIG. 9 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 902 is a cellular network that implements 3GPP standardized features. Accordingly, the telecommunications network 902 may support network slicing to provide different logical networks to different devices that are connected to the telecommunication network 902. For example, the telecommunications network 902 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 912 are configured to transmit and/or receive information without direct human interaction. For instance, a UE may be designed to transmit information to the access network 904 on a predetermined schedule, when triggered by an internal or external event, or in response to requests from the access network 904. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

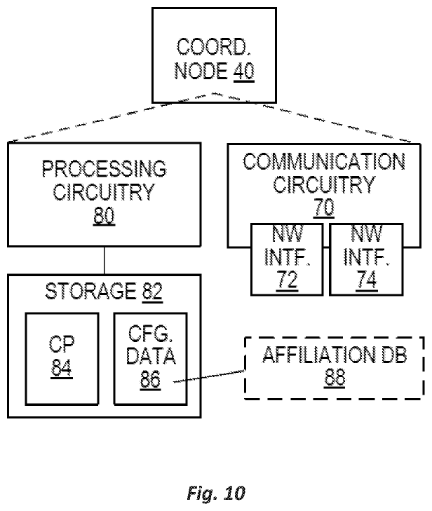

FIG. 10 illustrates an example embodiment of a coordination node 40, which may be configured to perform the functions of an event coordination function as described herein. Various elements or components constitute the coordination node 40, including communication circuitry 70, which may include one or more network interfaces 72 and 74 that communicatively couple the coordination node 40 directly or indirectly to one or more nodes in the RAN, such as to one or more gNBs, and/or to other CN nodes, and/or to one or more nodes in the cloud, such as one or more nodes providing a cloud management function as described above.

Other entities or components in the depicted coordination node 40 include processing circuitry 80, which includes or is associated with storage 82. The processing circuitry 80 comprises fixed circuitry, or preprogrammed circuitry, or programmable circuitry, or any combination of fixed, preprogrammed, and programmable circuitry. Non-limiting examples include one or more microprocessors, microcontrollers, Digital Signal Processors (DSPs), Field Programmable Gate Arrays (FPGAs), Complex Programmable Logic Devices (CPLDs), Application Specific Integrated Circuits (ASICS), or essentially any other arrangement of digital processing circuitry, such as combinational digital logic, sequential digital logic, or both. In at least one example, the processing circuitry 80 comprises one or more processors—e.g., microprocessors—that are specially adapted to perform the operations described herein based on executing computer program instructions from one or more computer programs stored in a computer-readable medium providing non-transitory storage for the computer program(s). “Non-transitory” does not necessarily mean unchanging but does connote at least some persistence, and various types of computer-readable media may be involved, such as a mix of non-volatile memory for long-term storage of the computer program(s) and volatile memory as working memory for program execution and scratch data.

Correspondingly, in one or more embodiments, the storage 82 stores one or more computer programs 84 comprising computer program instructions the execution of which by one or more processors realizes or implements the processing circuitry 80. The storage 82 may further store one or more items of configuration data 86, based on receiving it during live operation or based on it being pre-stored. The configuration data 86 comprises, for example, an affiliation database 88.

In at least one embodiment, given UEs or PDU sessions, for example, are “affiliated” for purposes of coordination if they are identified in the affiliation database 88 as being affiliated. By way of example, the affiliation database 88 comprises a data structure that logically associates pairs, triplets, or sets of UEs or PDU sessions as being affiliated. The affiliation database 88 may be pre-provisioned, or populated on the fly, based on detecting which UEs or PDU sessions operating in the network are affiliated. For example, receiving information from two UEs indicating that they are associated with the same remote device 16 provides a basis for recognizing them as being affiliated. The affiliation database may be used as a basis for matching lock requests, whether generated internally to the wireless network or received from a cloud management function in the cloud, to corresponding UEs and PDU sessions.

All of the operations and techniques described herein in connection with the event coordination function may be implemented in one or several coordination nodes 40. Likewise, operations and techniques described herein in connection with the cloud management function may be implemented in one or several similar nodes operating in the cloud. More generally, various implementations of the techniques described herein may be implemented in one or more coordination nodes 40 in each of multiple network domains. For instance, functionality like that described above for an event coordination function may be implemented in a first coordination node 40 operating in a first network domain, while functionality like that described herein for a cloud manager may be implemented in a first coordination node 40 operating in a second network domain.

### Example Embodiments

In view of the detailed techniques, apparatuses, and systems described above, it will be appreciated that embodiments of the presently disclosed concepts include, but are not limited to, the following enumerated examples:
1. A method for coordinating application-related events in multiple network domains, the method comprising:
   in a first network domain, receiving a request, from a second network domain, to prevent events with respect to a first communications path in the first network domain, for a communications module; and,
   in response to the request, preventing or delaying one or more actions in the first network domain that would interrupt connectivity in the first communication path.
2. The method of example embodiment 1, wherein the first communications path is one of multiple communications paths in the first network domain associated with the communications module.
3. The method of example embodiment 1 or 2, wherein the first network domain is a wireless communications network and the second network domain is a cloud network domain.
4. The method of example 3, wherein the first communications path includes a wireless connection between a first instance of a user equipment in the communications module and a first access point in the wireless communications network.
5. The method of example embodiment 4, wherein said preventing or delaying one or more actions in the first network domain comprises preventing or delaying a handover of the wireless connection.
6. The method of any one of example embodiments 3-5, wherein said preventing or delaying one or more actions in the first network domain comprises preventing or delaying a PDU Session Anchor (PSA) relocation event corresponding to the first communications path for the communications module.
7. The method of any one of example embodiments 1-6, wherein the request comprises one or more of any of the following parameters:
   an identifier for identifying the request in the first and second network domains;
   a stream or session identifier indicating which of one or more PDU sessions are affected by the request;
   a type of action planned by the second network domain, with respect to a communications path associated with the communications module in the second network domain;
   a parameter indicating an importance of an action planned by the second network domain, with respect to a communications path associated with the communications module in the second network domain;
   a parameter indicating a duration of an action planned by the second network domain, with respect to a communications path associated with the communications module in the second network domain;
   a parameter indicating a proposed duration for locking out events with respect to the first communications path in the first network domain;
   a parameter indicating how many of multiple PDU sessions associated with the communications module should remain operational.
8. The method of any one of example embodiments 1-7, wherein the method further comprises sending, to the second network domain, a message indicating that the request is granted.
9. The method of example embodiment 8, wherein the message indicating that the request is granted indicates a time period during which the one or more actions will be prevented.
10. The method of any one of example embodiments 1-9, wherein the method further comprises:
   receiving, from the second network domain, a message indicating a lock release; and,
   in response to receiving the message indicating the lock release, suspending any prevention or delay of one or more actions in the first network domain that would interrupt connectivity in the first communication path.
11. The method of any one of example embodiments 1-9, wherein the method further comprises:
   detecting, while preventing or delaying one or more actions in the first network domain that would interrupt connectivity in the first communication path in response to the request, a request to perform an action in the first network domain that would interrupt connectivity in the first communication path;
   evaluating relative priorities of the requested action in the first network domain and an event in the second network domain associated with the request; and,
   based on said evaluating, selectively informing the second network domain of whether the preventing or delaying one or more actions in the first network domain that would interrupt connectivity in the first communication path is to be suspended, in favor of the requested action in the first network domain.
12. A method for coordinating application-related events in multiple network domains in a system comprising at least a first network domain and second network domain, the method comprising:
   in the second network domain, determining that a temporary lock on actions regarding a first communication path in the first network domain is needed, to prevent service discontinuity for an application in the second network domain serving a communications module connected to the application through the first network domain; and
   sending a request, to the first network domain, to prevent events with respect to the first communications path in the first network domain, for the communications module.
13. The method of example embodiment 12, wherein the first communications path is one of multiple communications paths in the first network domain associated with the communications module.
14. The method of example embodiment 12 or 13, wherein the first network domain is a wireless communications network and the second network domain is a cloud network domain.
15. The method of example embodiment 14, wherein the first communications path includes a wireless connection between a first instance of a user equipment in the communications module and a first access point in the wireless communications network.
16. The method of any of example embodiments 12-15, wherein said determining that the temporary lock is needed comprises detecting, in the second network domain, any one or more of:
   an execution environment failure relating to the application;
   a virtual machine failure relating to the application;
   a server failure relating to the application; and a relocation of an application execution environment for the application.
17. The method of any one of example embodiments 12-16, wherein the request comprises one or more of any of the following parameters:
   an identifier for identifying the request in the first and second network domains;
   a stream or session identifier indicating which of one or more PDU sessions are affected by the request;
   a type of action planned by the second network domain, with respect to a communications path associated with the communications module in the second network domain;
   a parameter indicating an importance of an action planned by the second network domain, with respect to a communications path associated with the communications module in the second network domain;
   a parameter indicating a duration of an action planned by the second network domain, with respect to a communications path associated with the communications module in the second network domain;
   a parameter indicating a proposed duration for locking out events with respect to the first communications path in the first network domain;
   a parameter indicating how many of multiple PDU sessions associated with the communications module should remain operational.
18. The method of any one of example embodiments 12-17, wherein the method further comprises receiving, from the second network domain, a message indicating that the request is granted.
19. The method of example embodiment 18, wherein the message indicating that the request is granted indicates a time period during which the one or more actions will be prevented.
20. The method of any one of example embodiments 12-19, wherein the method further comprises:
   sending, to the first network domain, a message indicating a lock release.
21. A control node configured for operation in a first network domain, for coordinating application-related events in multiple network domains, the control node comprising:
   communication circuitry configured to communicatively couple the control node to one or more other nodes in the first network domain and to one or more nodes in a second network domain; and
   processing circuitry operatively associated with the communication circuitry and configured to:
      receive a request, from the second network domain, to prevent events with respect to a first communications path in the first network domain, for a communications module; and,
      in response to the request, prevent or delay one or more actions in the first network domain that would interrupt connectivity in the first communication path.
22. The control node of example embodiment 21, wherein the processing circuitry is configured to carry out a method according to any one of example embodiments 2-11.
23. A control node configured for operation in a second network domain, for coordinating application-related events in multiple network domains, the control node comprising:
   communication circuitry configured to communicatively couple the control node to one or more other nodes in the second network domain and to one or more nodes in a first network domain; and
   processing circuitry operatively associated with the communication circuitry and configured to:
      determine that a temporary lock on actions regarding a first communication path in the first network domain is needed, to prevent service discontinuity for an application in the second network domain serving a communications module connected to the application through the first network domain; and
      send a request, to the first network domain, to prevent events with respect to the first communications path in the first network domain, for the communications module.
24. The control node of example embodiment 23, wherein the processing circuitry is configured to carry out a method according to any one of example embodiments 12-20.
25. A system comprising a first control node according to example embodiment 21 and a second control node according to example embodiment 23.
26. A computer program product comprising program instructions for execution by a processor or processors of one or more control nodes, the program instructions being configured to cause the control node(s) to carry out a method according to any one of example embodiments 1-20.
27. A computer-readable medium comprising, stored thereupon, a computer program product according to example embodiment 26.

1-29. (canceled)

30. A method for coordinating application-related events in multiple network domains, the method comprising:
in a first network domain, receiving a request, from a second network domain, to prevent events with respect to a first communications path in the first network domain, for a communications module; and,
in response to the request, preventing or delaying one or more actions in the first network domain that would interrupt connectivity in the first communication path.

31. The method of claim 30, wherein the communications module comprises at least one instance of a user equipment (UE).

32. The method of claim 30, wherein the first communications path is one of multiple communications paths in the first network domain associated with the communications module.

33. The method of claim 30, wherein the first network domain is a wireless communications network and the second network domain is a cloud network domain, and wherein the first communications path includes a wireless connection between a first instance of a user equipment (UE) in the communications module and a first access point in the wireless communications network.

34. The method of 33, wherein said preventing or delaying one or more actions in the first network domain comprises preventing or delaying a handover of the wireless connection.

35. The method of claim 32, wherein said preventing or delaying one or more actions in the first network domain comprises preventing or delaying a protocol data unit Session Anchor (PSA) relocation event corresponding to the first communications path for the communications module.

36. The method of claim 30, wherein the request comprises one or more of any of the following parameters:
an identifier for identifying the request in the first and second network domains;
a stream or session identifier indicating which of one or more protocol data unit (PDU) sessions are affected by the request;
a type of action planned by the second network domain, with respect to a communications path associated with the communications module in the second network domain;
a parameter indicating an importance of an action planned by the second network domain, with respect to a communications path associated with the communications module in the second network domain;
a parameter indicating a duration of an action planned by the second network domain, with respect to a communications path associated with the communications module in the second network domain;
a parameter indicating a proposed duration for locking out events with respect to the first communications path in the first network domain;
a parameter indicating how many of multiple PDU sessions associated with the communications module should remain operational.

37. The method of claim 30, wherein the method further comprises sending, to the second network domain, a message indicating that the request is granted, the message indicating a time period during which the one or more actions will be prevented.

38. The method of claim 30, wherein the method further comprises:
receiving, from the second network domain, a message indicating a lock release; and,
in response to receiving the message indicating the lock release, suspending any prevention or delay of one or more actions in the first network domain that would interrupt connectivity in the first communication path.

39. The method of claim 30, wherein the method further comprises:
detecting, while preventing or delaying one or more actions in the first network domain that would interrupt connectivity in the first communication path in response to the request, a request to perform an action in the first network domain that would interrupt connectivity in the first communication path;
evaluating relative priorities of the requested action in the first network domain and an event in the second network domain associated with the request; and,
based on said evaluating, selectively informing the second network domain of whether the preventing or delaying one or more actions in the first network domain that would interrupt connectivity in the first communication path is to be suspended, in favor of the requested action in the first network domain.

40. A method for coordinating application-related events in multiple network domains in a system comprising at least a first network domain and second network domain, the method comprising:
in the second network domain, determining that a temporary lock on actions regarding a first communication path in the first network domain is needed, to prevent service discontinuity for an application in the second network domain serving a communications module connected to the application through the first network domain; and
sending a request, to the first network domain, to prevent events with respect to the first communications path in the first network domain, for the communications module.

41. The method of claim 40, wherein the communications module comprises at least one instance of a user equipment (UE).

42. The method of claim 40, wherein the first network domain is a wireless communications network and the second network domain is a cloud network domain, and wherein the first communications path includes a wireless connection between a first instance of a user equipment, UE, in the communications module and a first access point in the wireless communications network.

43. The method of claim 40, wherein said determining that the temporary lock is needed comprises detecting, in the second network domain, any one or more of:
an execution environment failure relating to the application;
a virtual machine failure relating to the application;
a server failure relating to the application; and
a relocation of an application execution environment for the application.

44. The method of claim 40, wherein the request comprises one or more of any of the following parameters:
an identifier for identifying the request in the first and second network domains;
a stream or session identifier indicating which of one or more protocol data unit, PDU, sessions are affected by the request;
a type of action planned by the second network domain, with respect to a communications path associated with the communications module in the second network domain;
a parameter indicating an importance of an action planned by the second network domain, with respect to a communications path associated with the communications module in the second network domain;
a parameter indicating a duration of an action planned by the second network domain, with respect to a communications path associated with the communications module in the second network domain;
a parameter indicating a proposed duration for locking out events with respect to the first communications path in the first network domain;
a parameter indicating how many of multiple PDU sessions associated with the communications module should remain operational.

45. The method of claim 40, wherein the method further comprises:
sending, to the first network domain, a message indicating a lock release.

46. A control node configured for operation in a first network domain, for coordinating application-related events in multiple network domains, the control node comprising:
communication circuitry configured to communicatively couple the control node to one or more other nodes in the first network domain and to one or more nodes in a second network domain; and
processing circuitry operatively associated with the communication circuitry and configured to:
receive a request, from the second network domain, to prevent events with respect to a first communications path in the first network domain, for a communications module; and,
in response to the request, prevent or delay one or more actions in the first network domain that would interrupt connectivity in the first communication path.

47. The control node of claim 46, wherein the request comprises one or more of any of the following parameters:
an identifier for identifying the request in the first and second network domains;
a stream or session identifier indicating which of one or more protocol data unit (PDU) sessions are affected by the request;
a type of action planned by the second network domain, with respect to a communications path associated with the communications module in the second network domain;
a parameter indicating an importance of an action planned by the second network domain, with respect to a communications path associated with the communications module in the second network domain;
a parameter indicating a duration of an action planned by the second network domain, with respect to a communications path associated with the communications module in the second network domain;
a parameter indicating a proposed duration for locking out events with respect to the first communications path in the first network domain;
a parameter indicating how many of multiple PDU sessions associated with the communications module should remain operational.

48. A control node configured for operation in a second network domain, for coordinating application-related events in multiple network domains, the control node comprising:
communication circuitry configured to communicatively couple the control node to one or more other nodes in the second network domain and to one or more nodes in a first network domain; and
processing circuitry operatively associated with the communication circuitry and configured to:
determine that a temporary lock on actions regarding a first communication path in the first network domain is needed, to prevent service discontinuity for an application in the second network domain serving a communications module connected to the application through the first network domain; and
send a request, to the first network domain, to prevent events with respect to the first communications path in the first network domain, for the communications module.

49. The control node of claim 48, wherein the processing circuitry is configured to determine that the temporary lock is needed by detecting, in the second network domain, any one or more of:
an execution environment failure relating to the application;
a virtual machine failure relating to the application;
a server failure relating to the application; and
a relocation of an application execution environment for the application.
